(19) United States
(12) Patent Application Publication
(10) Pub. No.: US 2023/0070091 A1
(43) Pub. Date: Mar. 9, 2023

(54) Removable Strap Collector

(71) Applicant: Jason Scott Earls, Morristown, TN (US)

(72) Inventor: Jason Scott Earls, Morristown, TN (US)

(21) Appl. No.: 17/445,838

(22) Filed: Aug. 25, 2021

(51) Int. Cl. B65H 54/58

(52) U.S. Cl. CPC B65H 54/585

(57) ABSTRACT

A device is installable on a strap for collecting a free end or excess portion of the strap. The device includes: a base removably securable on a portion of the strap, the base including a bracket located on a first side of the base and securable on the strap and a mount located on a second side of the base; a first leg having a first end and a second end that is distal from the first end, the first leg pivotally attached to the mount at the first end of the first leg; and a reel pivotally attached to the distal end of the first leg. The free end or excess portion of the strap is retained around the reel.

### FIELD

This disclosure relates to the field of straps, such as ratchet straps. More particularly, this disclosure relates to a strap collector for collecting excess portions of a strap.

### BACKGROUND

Various straps are commonly used for securing items such as cargo. Straps can include ratchet and other tie-down straps that may be tightened around or against an object, such as to keep the object in place. Existing straps typically include at least one loose free end that results from tightening of the strap. If the free end of the strap is not secured, the free end may flap due to wind when an object is transported. Flapping or movement of the free end of the strap may result in the free end becoming tangled or may cause the strap to loosen.

Attempts have been made to address loose ends of straps. For example, U.S. Pat. No. 7,100,902 to Lu describes a “Hand-pulled Device for Winding Binding Strap.” Although this device includes a mechanism for collecting excess strap, the mechanism is built into a ratchet portion of the strap and is otherwise incompatible with an existing strap. U.S. Pat. No. 10,000,148 to Haynes describes a “Strap Winding Apparatus and Method.” However, the device of Haynes is mountable on a ratchet portion of a strap and significantly increases the size of the ratchet. Other similar attempts have been made to collect excess strap but suffer from similar drawbacks.

What is needed, therefore, is a strap collector device that is removably securable on a strap to secure a loose end of the strap.

### SUMMARY

The above and other needs are met by a strap collector device that is removably securable on a strap to secure a loose end of the strap. In a first aspect, a device is installable on a strap for collecting a free end or excess portion of the strap. The device includes: a base removably securable on a portion of the strap, the base including a bracket located on a first side of the base and securable on the strap and a mount located on a second side of the base; a first leg having a first end and a second end that is distal from the first end, the first leg pivotally attached to the mount at the first end of the first leg; and a reel pivotally attached to the distal end of the first leg, wherein the free end or excess portion of the strap is retained around the reel.

In one embodiment, the device further includes a second leg having a first end and a second end that is distal from the first end, the second leg pivotally attached to the mount at the first end of the leg, wherein the reel is pivotally attached to the distal end of the second leg.

In another embodiment, the bracket of the base further includes a pair of opposing L-shaped brackets located on the second side of the base and oriented such that a gap exists between the pair of opposing L-shaped brackets.

In yet another embodiment, the device further includes: a first post located on a first side of the mount of the base, the first post including a neck located between the first post and the mount of the base; and a second post located on a second side of the mount of the base; a second post located on a second side of the mount of the base, the second post including a neck located between the second post and the mount of the base. The first leg is pivotally attached to the mount at the first post. The second leg is pivotally attached to the mount at the second post.

In one embodiment, each of the first leg and the second leg includes a bore formed through the first ends of the first leg and the second leg, the bore shaped to receive the first post and the second post through the first ends of the first leg and the second leg.

In a second aspect, a device is installable on a strap for collecting a free end or excess portion of the strap. The device includes: a base removably securable on a portion of the strap, the base including a bracket located on a first side of the base and securable on the strap and a mount located on a second side of the base; a first leg having a first end and a second end that is distal from the first end, the first leg pivotally attached to the mount at the first end of the first leg; and a second leg having a first end and a second end that is distal from the first end, the second leg pivotally attached to the mount at the first end of the leg, wherein the reel is pivotally attached to the distal end of the second leg; a reel pivotally attached to the distal end of the first leg and the distal end of the second leg. The free end or excess portion of the strap is retained around the reel.

In one embodiment, the device further includes: a first post located on a first side of the mount of the base, the first post including a neck located between the first post and the mount of the base; and a second post located on a second side of the mount of the base; a second post located on a second side of the mount of the base, the second post including a neck located between the second post and the mount of the base. The first leg is pivotally attached to the mount at the first post. The second leg is pivotally attached to the mount at the second post.

In a third aspect, a device is installable on a strap for collecting a free end or excess portion of the strap. The device includes: a base removably securable on a portion of the strap, the base including: a bracket located on a first side of the base and securable on the strap and a mount located on a second side of the base and a first post and an opposing second post located on ends of the base; a first leg having a first end and a second end that is distal from the first end, the first leg pivotally attached to the mount at the first post of the base; and a second leg having a first end and a second end that is distal from the first end, the second leg pivotally attached to the second post of the base; a reel pivotally attached to the distal end of the first leg and the distal end of the second leg. The free end or excess portion of the strap is retained around the reel.

### BRIEF DESCRIPTION OF THE DRAWINGS

Further features, aspects, and advantages of the present disclosure will become better understood by reference to the following detailed description, appended claims, and accompanying figures, wherein elements are not to scale so as to more clearly show the details, wherein like reference numbers indicate like elements throughout the several views, and wherein:

FIG. 1 shows a side view of a strap and a strap collector in a storage position according to one embodiment of the present disclosure;

FIG. 2 shows a side view of a strap collector and a partially wound strap when in use according to one embodiment of the present disclosure;

FIG. 3 shows a strap collector with a strap secured thereon according to one embodiment of the present disclosure;

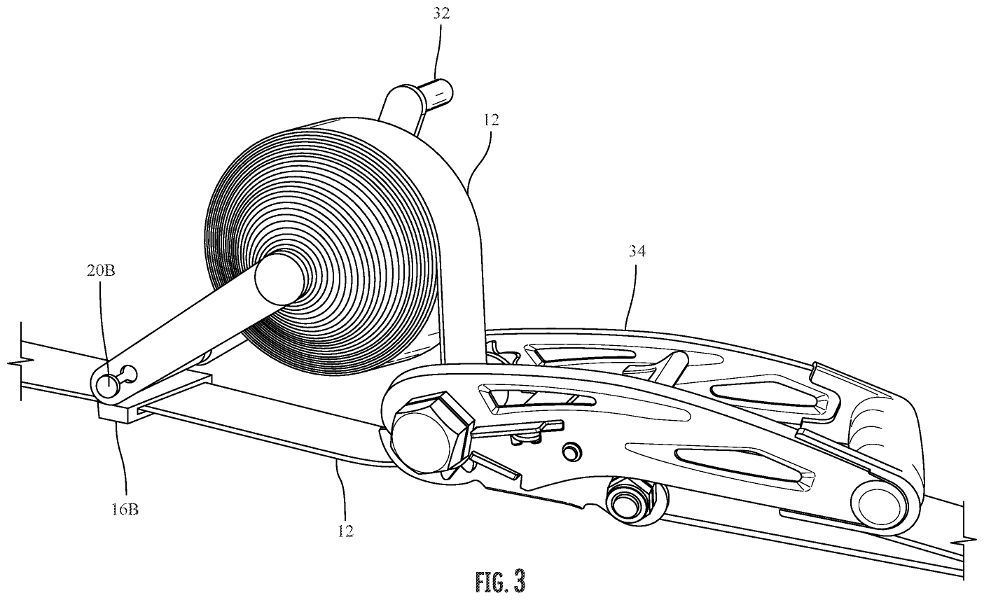

FIG. 4 shows a perspective side view of a strap and strap collector according to one embodiment of the present disclosure; and

FIG. 5 shows a strap collector with a strap wound thereon according to one embodiment of the present disclosure.

### DETAILED DESCRIPTION

Various terms used herein are intended to have particular meanings. Some of these terms are defined below for the purpose of clarity. The definitions given below are meant to cover all forms of the words being defined (e.g., singular, plural, present tense, past tense). If the definition of any term below diverges from the commonly understood and/or dictionary definition of such term, the definitions below control.

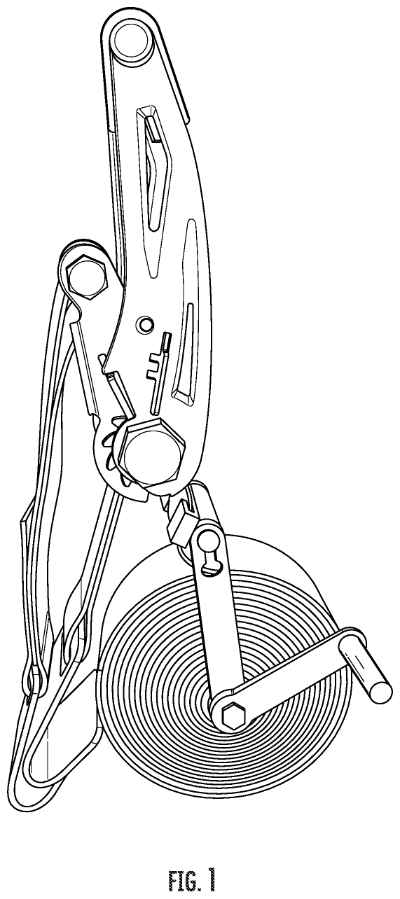

FIG. 1 shows a basic embodiment of a strap collector 10 for securing a loose end or excess portion of a strap 12. The strap collector 10 is securable on the strap 12 and is configured to collect the loose or excess portion of the strap 12, such as by winding the strap 12. The strap collector 10 is readily securable on an existing strap and may be easily removed when not in use, thereby allowing excess strap to be collected such as during transportation. The strap collector 10 is suitable for use with a variety of straps, including ratchet straps and other tie-down straps and may be used without modification to the strap or any ratchet or closure mechanism of the strap. Embodiments of the strap collector 10 described herein may be used in various suitable locations on the strap 12.

The strap collector 10 includes a base 14 that is shaped to substantially fit with or on the strap 12. The base 14 may include a bracket or other portion that is securable to the strap 12. As shown in FIG. 1, the bracket may include a first L-shaped bracket 16A and an opposing second L-shaped bracket 16B located on an underside of the base 14. The opposing first and second L-shaped brackets 16A and 16B are shaped to receive the strap 12 therebetween. The opposing first and second L-shaped brackets 16A and 16B are preferably spaced apart on the underside of the base 14 such that a gap is located between the opposing first and second L-shaped brackets 16A and 16B. The opposing first and second L-shaped brackets 16A and 16B are preferably oriented such that the first and second L-shaped brackets 16A and 16B retain the base 14 on the strap 12 while allowing the strap 12 to be removed through the gap formed between the opposing first and second L-shaped brackets 16A and 16B.

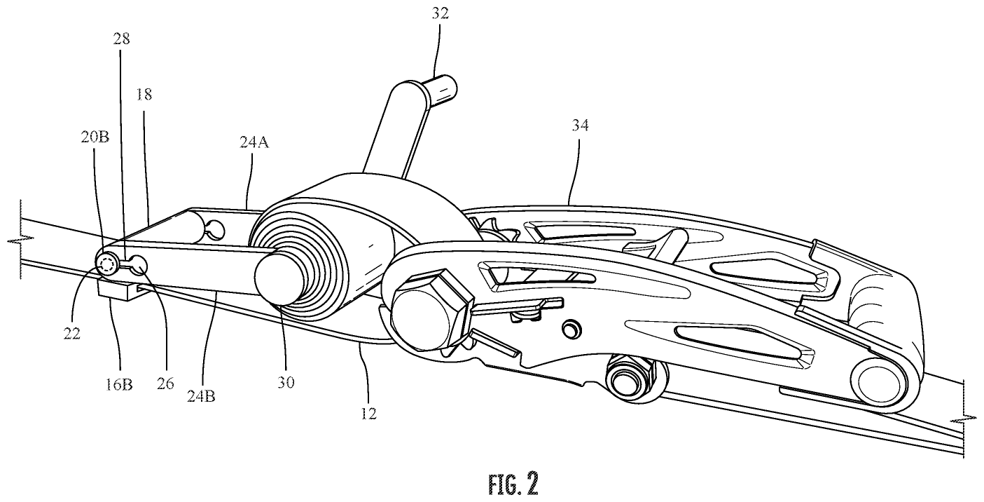

Referring to FIG. 2, the base 14 further includes a mount 18 located on an upper side thereof. The mount 18 is located opposite the opposing first and second L-shaped brackets 16A and 16B and preferably extends across a width of the base 14. The mount 18 may be wider than a width of the strap 12 on which the base 14 is to be installed. The mount 18 may be substantially cylindrical in shape. As shown in FIGS. 1 and 2, the mount 18 includes a first post 20A extending from a first end of the mount 18 and a second post 20B extending from a second end of the mount 18. The first post 20A and the second post 20B are preferably circular in shape and include a neck 22 located between ends of the mount 18 and the first post 20A and the second post 20B. The neck 22 of the first post 20A and the second post 20B preferably have a diameter that is less than a diameter of the first post 20A and the second post 20B.

With further reference to FIG. 2, the strap collector 10 further includes a first leg 24A pivotally attached to the mount 18 at the first post 20A and a second leg 24B pivotally attached to the mount 18 at the second post 20B. The first leg 24A and the second leg 24B are pivotally attached to the respective first post 20A and the second post 20B at first ends of the first leg 24A and the second leg 24B. The first leg 24A and the second leg 24B may be removably attached to the mount. For example, and as shown in the figures, each of the first leg 24A and the second leg 24B may include an aperture 26 shaped to receive the first post 20A and the second post 20B. The aperture 26 preferably has a diameter that is greater than a diameter of the first post 20A and the second post 20B such that the first post 20A and the second post 20B may fit through the aperture 26.

The first leg 24A and the second leg 24B further preferably include a slot 28 adjacent to the aperture 26. The slot 28 preferably has a width that is less than a diameter of the first post 20A and the second post 20B or may have a width 28 that is approximately the same as a diameter of the first post 20A and the second post 20B. The first leg 24A and the second leg 24B are retained on the mount 18 between the first post 20A and the mount 18 and the second post 20B and the mount 18.

The strap collector 10 includes a reel 30 mounted between distal ends of the first leg 24A and the second leg 24B. The reel 30 is preferably rotatably mounted on the first leg 24A and the second leg 24B such that a free end or excess portion of the strap 12 may be wound around the reel 30. The reel 30 may include a handle 32 secured thereto for winding the strap 12 around the reel 30.

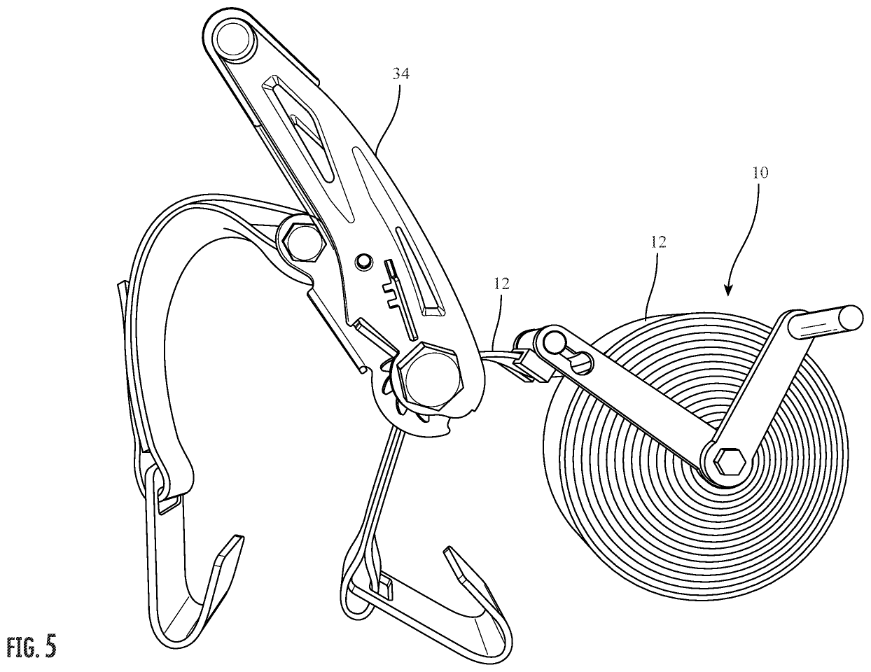

To install the strap collector 10 on an existing strap, the strap 12 may be placed between the opposing first and second L-shaped brackets 16A and 16B. The strap collector 10 is preferably located on the strap proximate to an existing ratchet 34 of the strap 12 or other buckle or fastening mechanism of the strap 12. A free end of the strap 12 may be subsequently wound around the reel 30 such that any excess or free portion of the strap 12 is retained on the reel 30. An amount of excess strap to be retained on the reel 30 may vary depending on whether the strap 12 secured around an object or whether the strap 12 is not secured to an object. The strap 12 may be secured around the reel 30 during storage or non-use of the strap, as shown in FIGS. 1 and 5. When a desired amount of the strap 12 is wound around the reel 30, the resulting winding of the strap 12 may be laid against the portion of the strap 12 on which the strap collector 10 is mounted. For example, by pivoting the first leg 24A and the second leg 24B relative to the portion of the strap 12 on which the strap collector 10 is mounted, the wound portion of the strap 12 may be laid against the portion of the strap 12 on which the strap collector 10 is mounted.

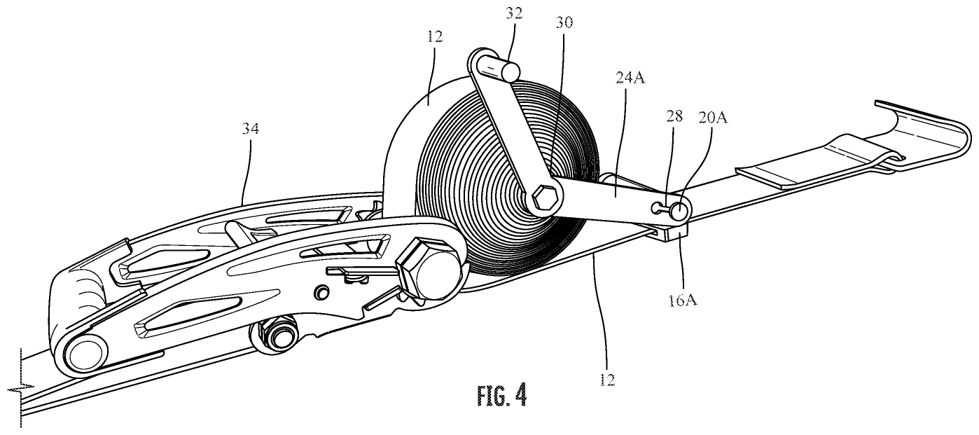

Referring to FIG. 4, the wound portion of the strap 12 is retained in a wound position around the reel 30 between the ratchet 34 of the strap 12 and the base 14 of the strap collector 10. For example, by tightly winding the free or excess portion of the strap 12 around the reel 30 and by allowing the reel 30 to pivot with respect to the mount 18, the wound portion of the strap 12 on the reel 30 is secured in place.

The strap collector 10 may be formed of various suitable materials such as plastics, composites, or metals. In one embodiment, the strap collector 10 is formed of a molded plastic or polymer such that the strap collector 10 is substantially rigid while providing some flexibility, such as in the first leg 24A and the second leg 24B to allow installation and removal of the first leg 24A and the second leg 24B on the mount 18.

Embodiments of the strap collector 10 described herein advantageously allow for excess strap to be stowed without requiring modification to the strap or a ratchet or other retention mechanism on the strap. Further, the strap collector 10 is adjustable and may be used with various straps and various types of retaining mechanisms. Further, the strap collector 10 is easily manufactured and installed on the strap 12. The strap collector 10 may be located on various suitable locations on the strap 12 and is not limited to use next to the ratchet 34 of the strap 12.

The foregoing description of preferred embodiments of the present disclosure has been presented for purposes of illustration and description. The described preferred embodiments are not intended to be exhaustive or to limit the scope of the disclosure to the precise form(s) disclosed. Obvious modifications or variations are possible in light of the above teachings. The embodiments are chosen and described in an effort to provide the best illustrations of the principles of the disclosure and its practical application, and to thereby enable one of ordinary skill in the art to utilize the concepts revealed in the disclosure in various embodiments and with various modifications as are suited to the particular use contemplated. All such modifications and variations are within the scope of the disclosure as determined by the appended claims when interpreted in accordance with the breadth to which they are fairly, legally, and equitably entitled.

What is claimed is:

1. A device installable on a strap for collecting a free end or excess portion of the strap, the device comprising:
a base removably securable on a portion of the strap, the base including a bracket located on a first side of the base and securable on the strap and a mount located on a second side of the base;
a first leg having a first end and a second end that is distal from the first end, the first leg pivotally attached to the mount at the first end of the first leg; and
a reel pivotally attached to the distal end of the first leg, wherein the free end or excess portion of the strap is retained around the reel.

2. The device of claim 1, further comprising a second leg having a first end and a second end that is distal from the first end, the second leg pivotally attached to the mount at the first end of the leg, wherein the reel is pivotally attached to the distal end of the second leg.

3. The device of claim 1, the bracket of the base further comprising a pair of opposing L-shaped brackets located on the second side of the base and oriented such that a gap exists between the pair of opposing L-shaped brackets.

4. The device of claim 2, the device further comprising:
a first post located on a first side of the mount of the base, the first post including a neck located between the first post and the mount of the base; and a second post located on a second side of the mount of the base;
a second post located on a second side of the mount of the base, the second post including a neck located between the second post and the mount of the base;
wherein the first leg is pivotally attached to the mount at the first post; and
wherein the second leg is pivotally attached to the mount at the second post.

5. The device of claim 4, each of the first leg and the second leg comprising a bore formed through the first ends of the first leg and the second leg, the bore shaped to receive the first post and the second post through the first ends of the first leg and the second leg.

6. A device installable on a strap for collecting a free end or excess portion of the strap, the device comprising:
a base removably securable on a portion of the strap, the base including a bracket located on a first side of the base and securable on the strap and a mount located on a second side of the base;
a first leg having a first end and a second end that is distal from the first end, the first leg pivotally attached to the mount at the first end of the first leg; and
a second leg having a first end and a second end that is distal from the first end, the second leg pivotally attached to the mount at the first end of the leg, wherein the reel is pivotally attached to the distal end of the second leg;
a reel pivotally attached to the distal end of the first leg and the distal end of the second leg; and
wherein the free end or excess portion of the strap is retained around the reel.

7. The device of claim 6, further comprising:
a first post located on a first side of the mount of the base, the first post including a neck located between the first post and the mount of the base; and a second post located on a second side of the mount of the base;
a second post located on a second side of the mount of the base, the second post including a neck located between the second post and the mount of the base;
wherein the first leg is pivotally attached to the mount at the first post; and
wherein the second leg is pivotally attached to the mount at the second post.

8. A device installable on a strap for collecting a free end or excess portion of the strap, the device comprising:
a base removably securable on a portion of the strap, the base including:
a bracket located on a first side of the base and securable on the strap and a mount located on a second side of the base and a first post and an opposing second post located on ends of the base;
a first leg having a first end and a second end that is distal from the first end, the first leg pivotally attached to the mount at the first post of the base; and
a second leg having a first end and a second end that is distal from the first end, the second leg pivotally attached to the second post of the base;
a reel pivotally attached to the distal end of the first leg and the distal end of the second leg; and
wherein the free end or excess portion of the strap is retained around the reel.
